(19) United States
(12) Patent Application Publication
(10) Pub. No.: US 2024/0283534 A1
(43) Pub. Date: Aug. 22, 2024

(54) TRANSMITTER, COMMUNICATION DEVICE, AND COMMUNICATION SYSTEM

(71) Applicant: NEC Corporation, Tokyo (JP)

(72) Inventors: Masaki Aizono, Tokyo (JP); Fujio Okumura, Kanagawa (JP)

(73) Assignee: NEC Corporation, Tokyo (JP)

(21) Appl. No.: 18/413,833

(22) Filed: Jan. 16, 2024

(30) Foreign Application Priority Data
Feb. 17, 2023 (JP) 2023-023182

(51) Int. Cl. H04B 10/11; G02B 3/08

(52) U.S. Cl. CPC H04B 10/11; G02B 3/08

(57) ABSTRACT

Provided is a transmitter including a light source that emits illumination light, a spatial light modulator that includes a modulation part to which the illumination light emitted from the light source is irradiated, a first annular reflector that has a first annular reflection surface irradiated with modulated light modulated by the modulation part, a second annular reflector that is disposed concentrically with the first annular reflector and has a second annular reflection surface irradiated with the modulated light reflected by the first annular reflection surface, a diffusion transmitter that is irradiated with the modulated light reflected by the second annular reflection surface, changes an optical path of the irradiated modulated light in a direction along a horizontal plane, and diffuses and transmits the modulated light having the changed optical path, and a ball lens that projects the light transmitted from the diffusion transmitter.

This application is based upon and claims the benefit of priority from Japanese Patent Application No. 2023-023182, filed on Feb. 17, 2023, the disclosure of which is incorporated herein in its entirety by reference.

### TECHNICAL FIELD

The present disclosure relates to a transmitter, a communication device, and a communication system.

### BACKGROUND ART

In spatial light communication in a free space, an optical signal (hereinafter, also referred to as a spatial light signal) propagating in the space is transmitted and received without using a medium such as an optical fiber. In order to transmit the spatial light signal in a wide range, it is preferable that a projection angle of projection light is as large as possible. For example, by using a light transmission device including a phase modulation-type spatial light modulator, the projection angle can be widened by controlling the pattern set in a modulation part of the spatial light modulator.

PTL 1 (JP 2021-026951 A) discloses an optical device intended to efficiently obtain desired light distribution characteristics. The device of PTL 1 includes a ball lens and a light source. The ball lens condenses and emits light. The light source has a light emission surface. The light source is disposed at a position where the light emission surface is closer to the ball lens than a focal position of the ball lens. The light source emits light to the ball lens side.

The device of PTL 1 condenses light of Lambertian distribution such as a light emitting diode (LED) and emits a light flux having a large beam diameter in one direction. The device of PTL 1 cannot emit a light flux having a large beam diameter in any direction along a horizontal plane.

An object of the present disclosure is to provide a transmitter or the like capable of transmitting a spatial light signal with an expanded beam diameter in any direction along a horizontal plane.

### SUMMARY

in A transmitter according to an aspect of the present disclosure includes a light source that emits illumination light, a spatial light modulator that includes a modulation part to which the illumination light emitted from the light source is irradiated, a first annular reflector that has a first annular reflection surface irradiated with modulated light modulated by the modulation part, a second annular reflector that is disposed concentrically with the first annular reflector and has a second annular reflection surface irradiated with the modulated light reflected by the first annular reflection surface, a diffusion transmitter that is irradiated with the modulated light reflected by the second annular reflection surface, changes an optical path of the irradiated modulated light in a direction along a horizontal plane, and diffuses and transmits the modulated light having the changed optical path, and a ball lens that projects the light transmitted from the diffusion transmitter.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a transmitter according to the present disclosure;

FIG. 2 is a conceptual diagram illustrating an example of the configuration of the transmitter according to the present disclosure;

FIG. 3 is a conceptual diagram for describing a diffusion transmitter of the transmitter according to the present disclosure;

FIG. 4 is a conceptual diagram illustrating an example of a configuration of a transmitter according to the present disclosure;

FIG. 5 is a conceptual diagram illustrating an example of a configuration of the transmitter according to the present disclosure;

FIG. 6 is a conceptual diagram for describing a diffusion transmitter of the transmitter according to the present disclosure;

FIG. 7 is a conceptual diagram for describing the diffusion transmitter of the transmitter according to the present disclosure;

FIG. 8 is a conceptual diagram illustrating an example of a configuration of a transmitter according to the present disclosure;

FIG. 9 is a conceptual diagram illustrating an example of a configuration of the transmitter according to the present disclosure;

FIG. 10 is a conceptual diagram for describing a diffusion transmitter of the transmitter according to the present disclosure;

FIG. 11 is a block diagram illustrating an example of a configuration of a communication device according to the present disclosure;

FIG. 12 is a block diagram illustrating an example of a configuration of a receiver included in the communication device according to the present disclosure;

FIG. 13 is a conceptual diagram illustrating an example of an internal configuration of the receiver included in the communication device according to the present disclosure;

FIG. 14 is a conceptual diagram illustrating an example of a configuration of the communication device according to the present disclosure;

FIG. 15 is an outer edge diagram illustrating an application example of the communication device according to the present disclosure;

FIG. 16 is a conceptual diagram illustrating an example of a configuration of a transmitter according to the present disclosure; and

FIG. 17 is a block diagram illustrating an example of a hardware configuration that executes control and processing according to the present disclosure.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the directions of the arrows in the drawings are merely examples, and do not limit the directions of light and signals. A line indicating a trajectory of light in the drawings is conceptual, and does not accurately indicate an actual traveling direction or state of light. For example, in the drawings, a change in a traveling direction or a state of light due to refraction, reflection, diffusion, or the like at an interface between air and a substance may be omitted, or a light flux may be expressed by one line. There is a case where hatching is not applied to the cross section for reasons such as an example of a light path is illustrated or the configuration is complicated.

### First Example Embodiment

First, a transmitter according to a first example embodiment will be described with reference to the drawings. The transmitter of the present example embodiment is used for optical space communication in which an optical signal (hereinafter, also referred to as a spatial light signal.) propagating in space is transmitted and received. The transmitter of the present example embodiment may be used for applications other than the optical space communication as long as the transmitter is used to transmit light propagating in space. The drawings used in the description of the present example embodiment are conceptual and do not accurately depict an actual structure.

The transmitter according to the present example embodiment receives notification light emitted from a communication target. In response to the detection of the received notification light, the transmitter of the present example embodiment specifies the position of the communication target that is an emission source of the notification light. The transmitter of the present example embodiment transmits the spatial light signal toward the specified direction of the notification target.

### Configuration

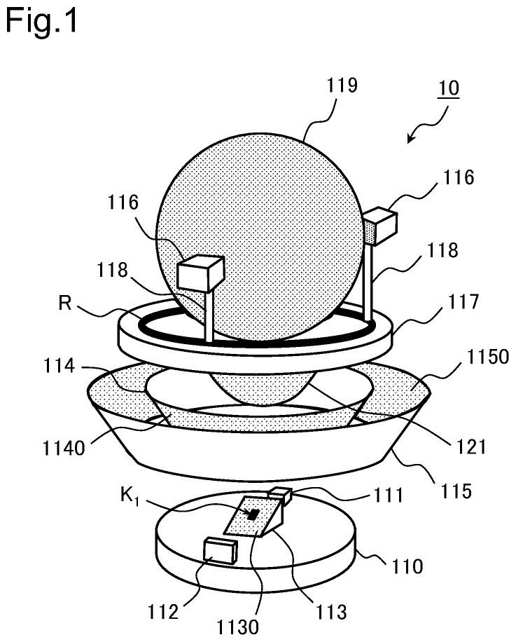

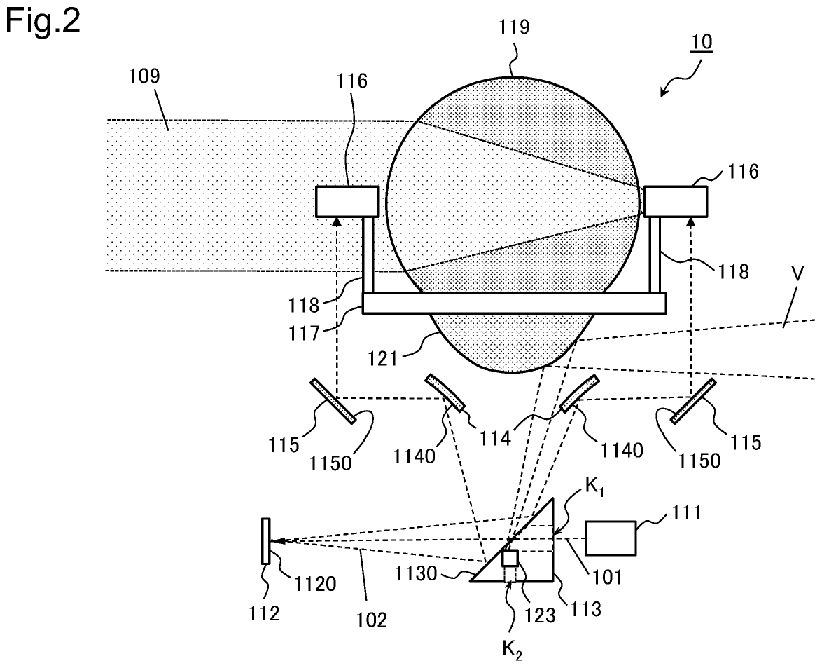

FIGS. 1 and 2 are conceptual diagrams illustrating an example of a configuration of a transmitter according to the present disclosure. FIG. 1 is a perspective view of the configuration of the transmitter according to the present disclosure as viewed from an obliquely upper perspective. FIG. 2 is a cross-sectional view of the configuration of the transmitter according to the present disclosure as viewed from a measurement perspective. Practically, the transmitter 10 is stored inside a housing having an opening or a window for transmitting a spatial light signal.

The transmitter 10 includes a light source 111, a spatial light modulator 112, a relay reflector 113, a first annular reflector 114, a second annular reflector 115, a diffusion transmitter 116, a support base 117, a strut 118, and a ball lens 119. The light source 111, the spatial light modulator 112, and the relay reflector 113 are disposed on an upper surface of a table 110. The first annular reflector 114 and the second annular reflector 115 constitute an annular reflector. The transmitter 10 includes a light receiving mirror 121 and a camera 123. The light receiving mirror 121 and the camera 123 constitute a notification light receiving unit. In a case where the position of the communication target that is the emission source of the notification light is not specified in response to the detection of the notification light, the notification light receiving unit may be omitted.

The light source 111 emits illumination light 101. An emission surface of the light source 111 is directed to the modulation part 1120 of the spatial light modulator 112 via a first through hole K₁ formed in the relay reflector 113. The illumination light 101 emitted from the light source 111 passes through the first through hole K₁ formed in the relay reflector 113 and is irradiated to the modulation part 1120 of the spatial light modulator 112. The light source 111 may be disposed inside the first through hole K₁ formed in the relay reflector 113.

The light source 111 includes at least one emitter (not illustrated). The emitter emits the illumination light 101 under the control of a communication control device (not illustrated). The illumination light 101 emitted from the light source 111 is irradiated to the modulation part 1120 of the spatial light modulator 112.

The emitter included in the light source 111 emits laser light of a predetermined wavelength band. The wavelength of the laser light emitted from the emitter is not particularly limited, and may be selected according to the application. For example, the emitter emits laser light in a visible or infrared wavelength band. For example, near infrared ray of 800 to 1000 nanometers (nm) can be given a laser class as compared with visible light, so that sensitivity can be improved as compared with visible light. For example, in the case of infrared rays in a wavelength band of 1.55 micrometers (μm), a laser light source having a higher output than near infrared rays of 800 to 1000 nm can be used. As a laser light source that emits infrared rays in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set. For example, the emitter may be a surface emitting element such as a PCSEL (Photonic Crystal Surface Emitting Laser) laser.

Each of the plurality of emission units is associated with any one of the plurality of modulation regions set in a modulation part 1120 of the spatial light modulator 112. The illumination light 101 emitted from each of the plurality of emission units travels toward the associated modulation region.

The spatial light modulator 112 is a phase modulation-type spatial light modulator. The spatial light modulator 112 includes the modulation part 1120. The spatial light modulator 112 is arranged at a position where the relay reflection surface 1130 of the relay reflector 113 and the modulation part 1120 face each other. The position where the spatial light modulator 112 is disposed is a position where modulated light 102 obtained by modulating the illumination light 101 emitted from the light source 111 is reflected toward the relay reflection surface 1130. For example, the spatial light modulator 112 is achieved by a spatial light modulator using ferroelectric liquid crystal, homogeneous liquid crystal, vertical alignment liquid crystal, or the like. For example, the spatial light modulator 112 can be achieved by liquid crystal on silicon (LCOS). The spatial light modulator 112 may be achieved by a micro electro mechanical system (MEMS). In the phase modulation-type spatial light modulator 112, the energy can be concentrated on the portion of the image by operating to sequentially switch the portion used for the projection of the projection light 109. Therefore, in the case of using the phase modulation-type spatial light modulator 112, when the outputs of the light emitters included in the light source 111 are the same, the image can be displayed brighter than other methods.

A plurality of modulation regions are set in the modulation part 1120 of the spatial light modulator 112. The number of modulation regions set in the modulation part 1120 is set in accordance with the number of light emitters included in the light source 111. Each of the plurality of modulation regions is associated with one of the plurality of light emitters included in the light source 111. Each of the plurality of modulation regions is irradiated with the illumination light 101 derived from the laser light emitted from the associated emitter. However, the correspondence relationship between the modulation region and the emitter is not particularly limited as long as the illumination light 101 derived from the laser light emitted from the emitter is incident on the modulation surface of the modulation region. The number of modulation regions set in the modulation part 1120 may be different from the number of light emitters included in the light source 111.

The modulation region is divided into a plurality of regions (also referred to as tiling). For example, the modulation region is divided into regions (also referred to as tiles) of a desired aspect ratio. A phase image is assigned to each of the plurality of tiles. Each of the plurality of tiles includes a plurality of pixels. A phase image corresponding to a projected image is set to each of the plurality of tiles. A phase image is tiled to each of the plurality of tiles allocated to the modulation region. For example, a phase image generated in advance is set in each of the plurality of tiles. When the modulation region is irradiated with the illumination light 101 in a state where the phase image is set to the plurality of tiles, the modulated light 102 that forms an image corresponding to the phase image of each tile is emitted. As the number of tiles set in the modulation region increases, a clear image can be displayed. However, when the number of pixels of each tile decreases, the resolution decreases. Therefore, the size and number of tiles set in the modulation region are set according to the application.

A pattern (also referred to as a phase image) corresponding to the image displayed by the projection light 109 is set in each of the plurality of modulation regions under the control of the communication control device. A pattern (phase image) is set in each of the plurality of modulation regions. The illumination light 101 with which each of the plurality of modulation regions is irradiated is modulated according to the pattern (phase image) set in the modulation region. The modulated light 102 modulated in each of the plurality of modulation regions travels toward the relay reflection surface 1130 of the relay reflector 113.

For example, a shield (not illustrated) may be disposed at a subsequent stage of the spatial light modulator 112. The shield is a frame that shields unnecessary light components included in the modulated light 102 and defines an outer edge of a display area of the projection light 109. For example, the shield is an aperture. In such an aperture, a slit-shaped opening is formed in a portion through which light (desired light) that forms a desired image passes. The desired light is first-order diffracted light. The shield causes the desired light to pass through and shields unwanted light components. For example, the shifter shields a ghost image including 0th-order light included in the modulated light 102, unnecessary first-order light appearing at a point symmetric position with respect to desired light with the 0th-order light as the center, and higher-order light of second or higher order. Details of the shield will not be described.

The relay reflector 113 has an outer shape of a right angle prism. The relay reflection surface 1130 is formed on an inclined surface of the relay reflector 113. An inclination angle of the relay reflection surface 1130 is 45 degrees. The relay reflector 113 is disposed between the light source 111 and the spatial light modulator 112. The relay reflector 113 is disposed below the first annular reflector 114. The first through hole K₁ is formed in the relay reflector 113. In the example of FIG. 2, the first through hole K₁ penetrates the relay reflector 113 in a left-right direction in the plane of a paper surface. A second through hole K₂ is formed in the relay reflector 113. In the example of FIG. 2, the second through hole K₂ penetrates the relay reflector 113 in an up-down direction in the plane of the paper surface. The camera 123 is disposed inside the second through hole K₂.

The relay reflection surface 1130 of the relay reflector 113 is irradiated with the modulated light 102 modulated by the modulation part 1120 of the spatial light modulator 112. The modulated light 102 irradiated to the relay reflection surface 1130 is reflected toward the first annular reflector 114 disposed above.

The first annular reflector 114 is an annular body having a shape corresponding to a side surface of a rotating body (truncated cone) having a circular lower surface (first bottom surface) having a first radius and a circular upper surface (second bottom surface) having a second radius larger than the first radius. The centers of the first bottom surface and the second bottom surface are the same. The first annular reflector 114 is surrounded by the second annular reflector 115. The first annular reflector 114 has a lower first annular surface and an upper second annular surface. A first annular reflection surface 1140 is formed on the first annular surface of the first annular reflector 114. The first annular reflection surface 1140 is formed of a concave curved surface. The curved first annular reflection surface 1140 is directed downward. The first annular reflection surface 1140 has a curvature corresponding to the projection angle of the projection light 109. For example, the first annular reflection surface 1140 has a shape of a circular columnar side surface. For example, the first annular reflection surface 1140 is a free-form surface or a spherical surface. For example, the first annular reflection surface 1140 may not be a single curved surface but may have a shape obtained by combining a plurality of curved surfaces. The first annular reflection surface 1140 may be a flat surface. For example, the first annular reflection surface 1140 may have a shape in which a curved surface and a flat surface are combined.

The first annular reflector 114 is disposed on the optical path of the modulated light 102 reflected by the relay reflection surface 1130 of the relay reflector 113. The first annular reflector 114 is arranged at a position where an unnecessary light component (also referred to as unnecessary light) of the modulated light 102 modulated by the modulation part 1120 of the spatial light modulator 112 is not emitted to the first annular reflection surface 1140. The unnecessary light is zero-order light or high-order light included in the modulated light 102. The first annular reflection surface 1140 is disposed to direct the emitted modulated light 102 toward the second annular reflector 115. The first annular reflection surface 1140 is irradiated with a light component (also referred to as desired light) of a projection target of the modulated light 102 modulated by the modulation part 1120. The modulated light 102 irradiated to the first annular reflection surface 1140 is reflected toward the second annular reflector 115 disposed around the first annular reflector 114.

The first annular reflection surface 1140 of the first annular reflector 114 is directed in any direction along the horizontal plane. Therefore, the first annular reflection surface 1140 can reflect the modulated light 102 in any direction along the horizontal plane by controlling the pattern (phase image) set in the modulation part 1120 of the spatial light modulator 112.

The second annular reflector 115 is an annular body having a shape corresponding to a side surface of a rotating body (truncated cone) having a circular lower surface (third bottom surface) having a third radius larger than the second radius and a circular upper surface (fourth bottom surface) having a fourth radius larger than the third radius. The centers of the third bottom surface and the fourth bottom surface are the same. The centers of the third bottom surface and the fourth bottom surface coincide with the centers of the first bottom surface and the second bottom surface of the first annular reflector 114. That is, the first annular reflector 114 and the second annular reflector 115 are concentrically arranged in a plan view. The second annular reflector 115 is disposed so as to surround the periphery of the first annular reflector 114. The second annular reflector 115 has a lower third annular surface and an upper fourth annular surface. A second annular reflection surface 1150 is formed on the fourth annular surface of the second annular reflector 115. The second annular reflection surface 1150 faces the first annular reflection surface 1140 of the first annular reflector 114. The second annular reflection surface 1150 is directed to the diffusion transmitter 116 disposed above. The second annular reflection surface 1150 is irradiated with the modulated light 102 reflected by the first annular reflection surface 1140. The modulated light 102 irradiated to the second annular reflection surface 1150 is reflected toward the diffusion transmitter 116.

The diffusion transmitter 116 is disposed at the upper end of the strut 118. The diffusion transmitter 116 is disposed so as to be movable about the ball lens 119. The diffusion transmitter 116 moves around the ball lens 119 in accordance with the movement of the strut 118 along a circular orbit R arranged on the upper surface of the strut 118. The position of the diffusion transmitter 116 is changed according to control of a communication control device (not illustrated). The position of the diffusion transmitter 116 is changed such that the projection light 109 is projected in the arrival direction of the spatial light signal transmitted from the communication target. The diffusion transmitter 116 is irradiated with the modulated light 102 reflected by the second annular reflection surface 1150 of the second annular reflector 115. The diffusion transmitter 116 changes the optical path of the emitted modulated light 102 in a direction along the horizontal plane. The diffusion transmitter 116 diffuses and transmits the modulated light 102 whose optical path has been changed.

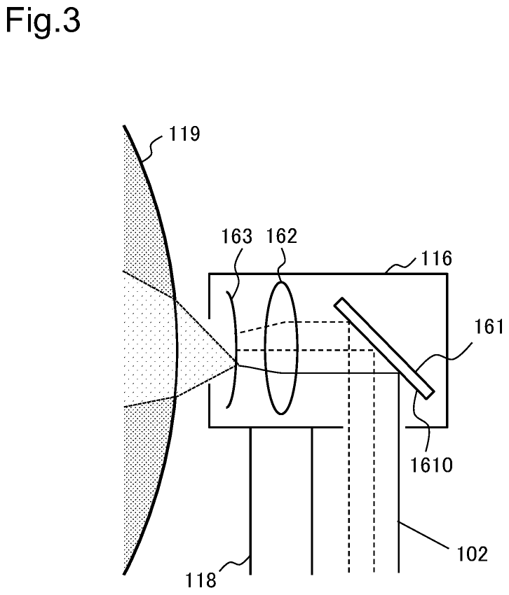

FIG. 3 is a conceptual diagram illustrating an example of a configuration of the diffusion transmitter 116. FIG. 3 is a diagram of the internal configuration of the housing of the diffusion transmitter 116 as viewed from a side perspective. The diffusion transmitter 116 includes a reflecting mirror 161, a concentrator 162, and a diffuser 163. An opening is formed below the housing of the diffusion transmitter 116. The opening of the housing faces the second annular reflection surface 1150 of the second annular reflector 115.

The reflecting mirror 161 has a reflecting surface 1610. The reflecting surface 1610 is directed obliquely downward. The reflecting surface 1610 is directed toward the incident surface of the concentrator 162. The reflecting surface 1610 is irradiated with the modulated light 102 reflected by the second annular reflection surface 1150 of the second annular reflector 115 through the opening of the housing. The reflecting surface 1610 reflects the emitted modulated light 102 toward the ball lens 119. The modulated light 102 irradiated to the reflecting surface 1610 of the reflecting mirror 161 is reflected toward the incident surface of the concentrator 162.

The concentrator 162 (also referred to as a lens) is a biconvex lens having a convex incident surface and a convex emission surface. The concentrator 162 is disposed between the reflecting mirror 161 and the diffuser 163. The incident surface of the concentrator 162 is directed toward the reflecting surface 1610 of the reflecting mirror 161. The emission surface of the concentrator 162 is directed toward the incident surface of the diffuser 163. The modulated light 102 reflected by the reflecting surface 1610 of the reflecting mirror 161 is incident on the incident surface of the concentrator 162. The modulated light 102 incident on the incident surface of the concentrator 162 is focused according to the refractive index of the concentrator 162 and emitted from the emission surface. The light emitted from the emission surface of the concentrator 162 travels toward the diffuser 163. When the traveling direction of the modulated light 102 is changed by the concentrator 162, the angle in the vertical direction of the light emitted from the emission surface of the diffuser 163 is changed.

The diffuser 163 (also referred to as a transparent diffuser) is a transparent diffuser plate through which light having a wavelength band of a spatial light signal (projection light 109) to be transmitted is transmitted. The diffuser 163 has a curved shape with a constant distance from the surface of the ball lens 119. The diffuser 163 has a convex incident surface and a concave emission surface. The incident surface of the diffuser 163 is directed toward the emission surface of the concentrator 162. The light focused by the concentrator 162 is incident on the incident surface of the diffuser 163. The light incident from the incident surface of the diffuser 163 is diffused according to the radiation angle of the diffuser 163 and emitted from the emission surface. The light emitted from the emission surface of the diffuser 163 travels toward the ball lens 119.

The diffuser 163 is a transmissive diffuser. On the incident surface (convex surface) of the diffuser 163, minute concave lenses randomly arranged are formed in an array. The light condensed by the concentrator 162 is incident on the diffuser 163. The diffuser 163 diffuses the incident light by micro-lenses formed in an array shape. The light diffused by the diffuser 163 travels toward the ball lens 119. The light incident from the incident surface is diffused at the position where the micro-lens is formed. Therefore, the range of light to be incident on the ball lens 119 can be shaped according to the range in which the micro-lens is formed.

The diffuser 163 is preferably made of a material through which a spatial light signal is easily transmitted. For example, the diffuser 163 can be formed using a transparent substrate such as polycarbonate, polyester, acrylic, or glass. The diffusion angle of the diffuser 163 can be adjusted by the state of the micro-lens. The diffusion angle of the light after passing through the diffuser 163 corresponds to a square root value of the sum of the square of the divergence angle of the incident light and the square of the diffusion angle of the diffuser 163. The smaller the size and the larger the density of the micro-lens, the larger the diffusion angle of the diffuser 163. The diffusion angle of the light after passing through the diffuser 163 may be adjusted according to the diameter of the ball lens 119, the distance between the diffuser 163 and the ball lens 119, and the like. For example, the radiation angle of the diffuser 163 is adjusted to about 45 degrees.

The support base 117 is a base that supports the diffusion transmitter 116, the strut 118, the ball lens 119, and the light receiving mirror 121. A recess or an opening is formed at the center of the upper surface of the support base 117. The ball lens 119 is placed above the recess or opening formed at the center of the support base 117. The light receiving mirror 121 is disposed below the support base 117. A circular orbit R having a circular shape is arranged on the upper surface of the support base 117 so as to annularly surround a recess or an opening formed at the center. The circular orbit R has a circumference overlapping with the condensing region of the ball lens 119 in a plan view. The strut 118 is movably installed on the circular orbit R arranged on the upper surface of the support base 117.

The strut 118 is a column that supports the diffusion transmitter 116. A diffusion transmitter 116 is disposed above the strut 118. The lower portion of the strut 118 is installed so as to be movable with respect to the circular orbit R arranged on the upper surface of the support base 117. The position of the strut 118 is changed along the circular orbit R according to the control of the communication control device (not illustrated). The strut 118 may have a structure that expands and contracts in the vertical direction. In this case, the height of the strut 118 vertically moves up and down under the control of the communication control device.

The ball lens 119 is a spherical lens. The ball lens 119 has a spherical shape when viewed from a voluntary angle. The light diffused by the diffuser 163 of the diffusion transmitter 16 is incident on the ball lens 119. The ball lens 119 converts the incident light into projection light 109 of substantially parallel light and emits the projection light. The projection light 109 emitted from the ball lens 119 travels toward a communication target (not illustrated) arranged in the direction along the horizontal plane.

For example, the ball lens 119 can be made of a material such as glass, crystal, or resin. In the case of receiving a spatial light signal in the visible region, the ball lens 119 can be achieved by a material that transmits light in the visible region. For example, optical glass such as crown glass or flint glass can be applied to the ball lens 119. For example, crown glass such as BK can be applied to the ball lens 119. For example, a flint glass such as LaSF can be applied to the ball lens 119. For example, quartz glass can be applied to the ball lens 119. For example, a crystal such as sapphire can be applied to the ball lens 119. For example, a transparent resin such as acryl can be applied to the ball lens 119.

When the spatial light signal is near infrared rays, a material that transmits the near infrared rays is used for the ball lens 119. For example, in the case of receiving a spatial light signal in a near infrared region of about 1.5 μm, a material such as silicon can be applied to the ball lens 119 in addition to glass, crystal, resin, and the like. In a case where the spatial light signal is infrared rays, a material that transmits infrared rays is used for the ball lens 119. For example, in a case where the spatial light signal is an infrared ray, silicon, germanium, or a chalcogenide material can be applied to the ball lens 119. The material of the ball lens 119 is not limited as long as light in the wavelength region of the spatial light signal can be transmitted/refracted. The material of the ball lens 119 may be appropriately selected according to the required refractive index and use.

The light receiving mirror 121 is a reflector having a curved reflecting surface. The light receiving mirror 121 has a circular shape in a plan view. The light receiving mirror 121 has a circular upper surface (first surface) having a first radius and a curved lower surface (light receiving/reflecting surface). The light receiving mirror 121 is disposed below the support base 117 with the light receiving/reflecting surface facing downward. The light receiving/reflecting surface on the lower surface of the light receiving mirror 121 forms a smooth curved surface from the peripheral edge toward the center. In other words, the light receiving mirror 121 is a reflecting mirror having a curved light receiving/reflecting surface.

The reflecting surface of the light receiving mirror 121 has a curvature that reflects the light V arriving from the direction along the horizontal plane toward the second through hole K₂ of the relay reflector 113. The shape of the reflecting surface of the light receiving mirror 121 is not limited. For example, the reflecting surface of the light receiving mirror 121 may be a free-form surface or a spherical surface. For example, the reflecting surface of the light receiving mirror 121 may not be a single curved surface but may have a shape in which a plurality of curved surfaces are combined. The reflecting surface may be a flat surface. For example, the reflecting surface of the light receiving mirror 121 may have a shape in which a curved surface and a flat surface are combined. The light V arriving at the transmitter 10 from the direction along the horizontal plane is reflected by the reflecting surface of the light receiving mirror 121, and is imaged by the camera 123 disposed in the second through hole K₂ of the relay reflector 113.

The camera 123 is disposed in the second through hole K₂ of the relay reflector 113 with the lens facing upward. In other words, the camera 123 is disposed in the second through hole K₂ of the relay reflector 113 with the imaging direction facing upward. As long as a digital image can be imaged, the type and specification of the camera 123 are not limited. The camera 123 images an image of the light V reflected by the reflecting surface of the light receiving mirror 121. The camera 123 outputs image data corresponding to the imaged light V to a communication control device (not illustrated). The image data imaged by the camera 123 is used to detect the notification light transmitted from the communication target. In response to the detection of the notification light, the communication control device (not illustrated) specifies the position of the communication target that is a transmission source of the notification light. The communication control device changes the position of the strut 118 so that a light transmission surface of the diffusion transmitter 116 faces the specified direction of the communication target. As a result, the transmitter 10 can transmit the spatial light signal (communication light) toward the communication target.

As described above, the transmitter of the present example embodiment includes the light source, the spatial light modulator, the relay reflector, the first annular reflector, the second annular reflector, the diffusion transmitter, the ball lens, the camera, and the light receiving reflector. The light source is disposed at a position through which the illumination light passes toward the relay reflection surface via the first through hole of the relay reflector. The light source emits the illumination light. The spatial light modulator includes the modulation part irradiated with the illumination light emitted from the light source. The spatial light modulator is disposed at a position where the relay reflection surface of the relay reflector and the modulation part face each other. The position where the spatial light modulator is disposed is a position where modulated light obtained by modulating the illumination light emitted from the light source is reflected toward the relay reflection surface. The relay reflector is disposed between the light source and the spatial light modulator at a position where the modulated light modulated by the modulation part of the spatial light modulator is reflected toward the first annular reflection surface of the first annular reflector. The relay reflector has the outer shape of a right angle prism in which the relay reflection surface is formed on the inclined surface. The first through hole penetrating the relay reflection surface along the horizontal direction and the second through hole penetrating the relay reflection surface along the vertical direction are formed in the relay reflector. The first annular reflector has the first annular reflection surface irradiated with the modulated light modulated by the modulation part. The second annular reflector is disposed concentrically with the first annular reflector. The second annular reflector has the second annular reflection surface irradiated with the modulated light reflected by the first annular reflection surface. The diffusion transmitter is disposed in the condensing region of the ball lens by the strut. The strut is movably installed along a circular orbit overlapping with the condensing region of the ball lens in a plan view. The diffusion transmitter includes the reflecting mirror, the lens, and the transparent diffuser. The reflecting mirror reflects the modulated light reflected by the second annular reflection surface of the second annular reflector toward the ball lens. The lens collects the modulated light reflected by the reflecting mirror. The transparent diffuser diffuses the modulated light condensed by the lens. The camera is disposed in the second through hole of the relay reflector with the imaging direction facing upward. The light receiving mirror has a curved light receiving/reflecting surface. The light receiving/reflecting surface reflects light arriving from the horizontal direction toward the second through hole.

The transmitter of the present example embodiment can irradiate a voluntary position of the first annular reflection surface with the modulated light by controlling the pattern (phase image) set in the modulation part of the spatial light modulator. The modulated light irradiated to the first annular reflection surface is irradiated to the diffusion reflector via the second annular reflection surface. The diffusion reflector changes an optical path of the emitted modulated light in a direction along a horizontal plane. The ball lens diffuses the modulated light whose optical path has been changed and transmits the modulated light toward the ball lens. The light whose beam diameter is expanded by the diffusion transmitter is projected as a spatial light signal via the ball lens. Therefore, according to the transmitter of the present example embodiment, it is possible to transmit the spatial light signal with the expanded beam diameter in any direction along the horizontal plane.

The transmitter of the present example embodiment can voluntarily change the transmission direction of the spatial light signal in the horizontal plane by moving the strut on which the diffusion transmitter is installed along the circular orbit overlapping the condensing region of the ball lens in a plan view. The communication control device connected to the transmitter of the present example embodiment specifies the presence or absence and the position of the communication target according to the notification light detected by the camera. The communication control device directs the light transmission surface of the diffusion transmitter in the direction of the specified communication target. Therefore, according to the transmitter of the present example embodiment, the transmission direction of the spatial light signal can be adjusted toward the direction of the communication target.

### Second Example Embodiment

Next, a transmitter according to a second example embodiment will be described with reference to the drawings. The transmitter of the present example embodiment differs from the transmitter according to the first example embodiment in the configuration of the projection unit.

### Configuration

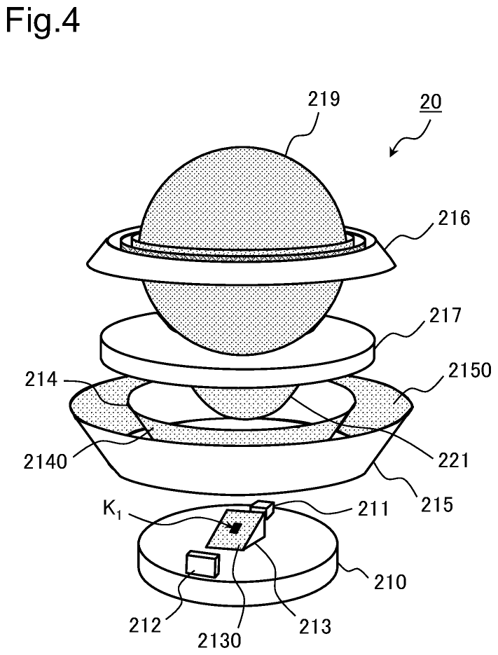

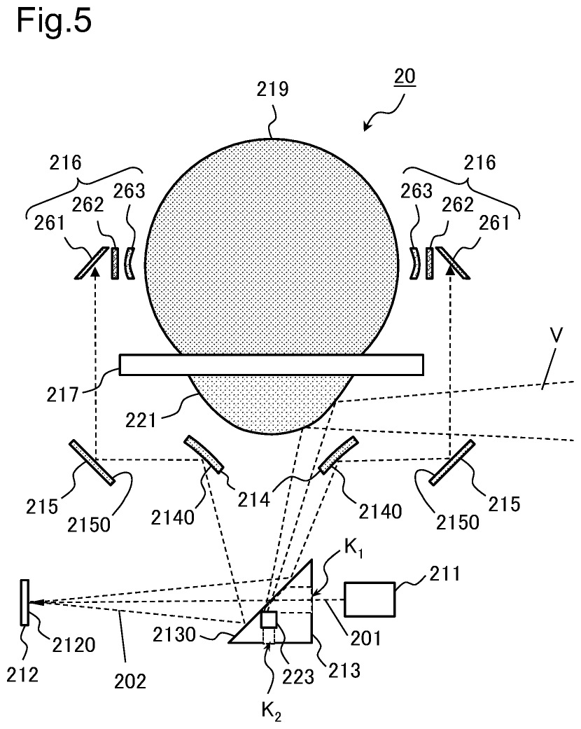

FIGS. 4 and 5 are conceptual diagrams illustrating an example of a configuration of a transmitter according to the present disclosure. FIG. 4 is a perspective view of the configuration of the transmitter according to the present disclosure as viewed from an obliquely upper perspective. FIG. 5 is a cross-sectional view of the configuration of the transmitter according to the present disclosure as viewed from a measurement perspective. Practically, the transmitter 20 is stored inside a housing having an opening or a window for transmitting a spatial light signal.

The transmitter 20 includes a light source 211, a spatial light modulator 212, a relay reflector 213, a first annular reflector 214, a second annular reflector 215, a diffusion transmitter 216, and a ball lens 219. The light source 211, the spatial light modulator 212, and the relay reflector 213 are disposed on an upper surface of a table 210. The first annular reflector 214 and the second annular reflector 215 constitute an annular reflector. The transmitter 20 includes a light receiving mirror 221 and a camera 223. The light receiving mirror 221 and the camera 223 constitute a notification light receiving unit. In a case where the position of the communication target that is the emission source of the notification light is not specified in response to the detection of the notification light, the notification light receiving unit may be omitted. The light source 211, the spatial light modulator 212, the relay reflector 213, the first annular reflector 214, the second annular reflector 215, the ball lens 219, the light receiving mirror 221, and the camera 223 have the same configurations as those of the first example embodiment. Therefore, hereinafter, the description of these configurations will be omitted, and the diffusion transmitter 216 will be mainly described.

The illumination light 201 emitted from the light source 211 is irradiated to the modulation part 2120 of the spatial light modulator 212. A plurality of modulation regions are set in the modulation part 2120. The Illumination light 201 irradiated to the modulation part 2120 is modulated according to a pattern (phase image) set in each of the plurality of modulation regions. The modulated light 202 modulated in each of the plurality of modulation regions travels toward the relay reflection surface 2130 of the relay reflector 213. The relay reflection surface 2130 of the relay reflector 213 is irradiated with the modulated light 202. The modulated light 202 irradiated to the relay reflection surface 2130 is reflected toward the first annular reflection surface 2140 of the first annular reflector 214 disposed above. The modulated light 202 irradiated to the first annular reflection surface 2140 is reflected toward the second annular reflection surface 2150 of the second annular reflector 215 disposed around the first annular reflector 214. The second annular reflection surface 2150 is irradiated with the modulated light 202 reflected by the first annular reflection surface 2140. The modulated light 202 irradiated to the second annular reflection surface 2150 is reflected toward the diffusion transmitter 216.

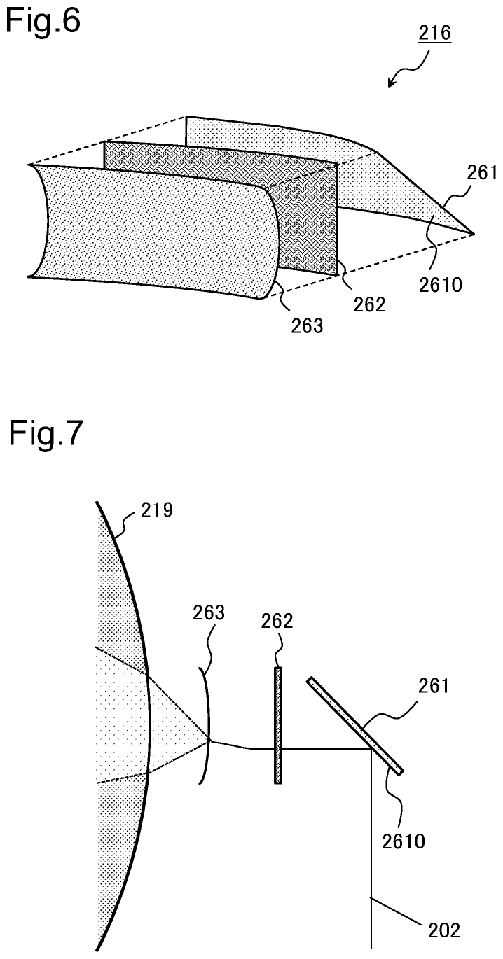

FIGS. 6 and 7 are conceptual diagrams illustrating an example of a configuration of the diffusion transmitter 216. FIG. 6 is a diagram of a part of the diffusion transmitter 216 as viewed from an obliquely upper perspective. FIG. 7 is a cross-sectional view of the diffusion transmitter 216 and the ball lens 219. The diffusion transmitter 216 includes a reflecting mirror 261, a concentrator 262, and a diffuser 263. The diffusion transmitter 216 is disposed around the ball lens 219 by a support (not illustrated). The width of the diffusion transmitter 216 in the vertical direction is preferably as narrow as possible so as not to disturb the optical path of the projection light transmitted from the ball lens 219.

The reflecting mirror 261 is an annular reflector having a shape corresponding to a side surface of a rotating body (truncated cone) having a circular lower surface (fifth bottom surface) having the same radius (fifth radius) as the upper surface (fourth bottom surface) of the second annular reflector 215 and a circular upper surface (sixth bottom surface) having a sixth radius smaller than the fifth radius. The centers of the fifth bottom surface and the sixth bottom surface are the same. The centers of the fifth bottom surface and the sixth bottom surface coincide with the centers of the third bottom surface and the fourth bottom surface of the second annular reflector 215. That is, the reflecting mirror 261, the first annular reflector 214, and the second annular reflector 215 are concentrically disposed in a plan view. The reflecting mirror 261 is arranged so as to surround the periphery of the ball lens 219.

Reflecting mirror 261 has a lower fifth annular surface and an upper sixth annular surface. An annular reflection surface 2610 is formed on the fifth annular surface of the reflecting mirror 261. The annular reflection surface 2610 is directed toward the second annular reflection surface 2150 of the second annular reflector 215. The annular reflection surface 2610 is directed toward the incident surface of the concentrator 262. The annular reflection surface 2610 is irradiated with the modulated light 202 reflected by the second annular reflection surface 2150 of the second annular reflector 215. The modulated light 202 irradiated to the annular reflection surface 2610 of the reflecting mirror 261 is reflected toward the incident surface of the concentrator 262.

The concentrator 262 (also referred to as an annular Fresnel lens) is a Fresnel lens formed in an annular shape. The concentrator 262 is disposed between the reflecting mirror 261 and the diffuser 263. The incident surface of the concentrator 262 is directed toward the annular reflection surface 2610 of the reflecting mirror 261. The emission surface of the concentrator 262 is directed toward the incident surface of the diffuser 263. The modulated light 202 reflected by the annular reflection surface 2610 of the reflecting mirror 261 is incident on the incident surface of the concentrator 262. The modulated light 202 incident on the incident surface of the concentrator 262 is focused according to the refractive index of the concentrator 262 and emitted from the emission surface. The light emitted from the emission surface of the concentrator 262 travels toward the diffuser 263. When the traveling direction of the modulated light 202 is changed by the concentrator 262, the angle in the vertical direction of the light emitted from the emission surface of the diffuser 263 is changed.

The diffuser 263 (also referred to as a transparent annular diffuser) is a transparent annular diffusion plate through which light in a wavelength band of a spatial light signal (projection light) to be transmitted passes. The diffuser 263 has a curved shape with a constant distance from the surface of the ball lens 219. The diffuser 263 has a convex incident surface and a concave emission surface. The incident surface of the diffuser 263 is directed toward the emission surface of the concentrator 262. The light focused by the concentrator 262 is incident on the incident surface of the diffuser 263. The light incident from the incident surface of the diffuser 263 is diffused according to the radiation angle of the diffuser 263 and emitted from the emission surface. The light emitted from the emission surface of the diffuser 263 travels toward the ball lens 219.

The diffuser 263 is a transmissive annular diffusion plate (also referred to as an annular transparent diffusion plate). The diffuser 263 is made of the same material as the diffuser 163 of the first example embodiment. On the incident surface (convex surface) of the diffuser 263, minute concave lenses randomly arranged are formed in an array. The light condensed by the concentrator 262 is incident on the diffuser 263. The diffuser 263 diffuses the incident light by micro-lenses formed in an array shape. The light diffused by the diffuser 263 travels toward the ball lens 219. The light incident from the incident surface is diffused at the position where the micro-lens is formed. Therefore, the range of light to be incident on the ball lens 219 can be shaped according to the range in which the micro-lens is formed.

The ball lens 219 is disposed on the support base 217. The ball lens 219 is fitted into a recess or an opening formed on the upper surface of the support base 217. The light diffused by the diffuser 263 of the diffusion transmitter 216 is incident on the ball lens 219. The ball lens 219 converts the incident light into projection light of substantially parallel light and emits the projection light. The projection light emitted from the ball lens 219 travels toward a communication target (not illustrated) arranged in a direction along the horizontal plane.

As described above, the transmitter of the present example embodiment includes the light source, the spatial light modulator, the relay reflector, the first annular reflector, the second annular reflector, the diffusion transmitter, the ball lens, the camera, and the light receiving reflector. The light source is disposed at a position through which the illumination light passes toward the relay reflection surface via the first through hole of the relay reflector. The light source emits the illumination light. The spatial light modulator includes the modulation part irradiated with the illumination light emitted from the light source. The spatial light modulator is disposed at a position where the relay reflection surface of the relay reflector and the modulation part face each other. The position where the spatial light modulator is disposed is a position where modulated light obtained by modulating the illumination light emitted from the light source is reflected toward the relay reflection surface. The relay reflector is disposed between the light source and the spatial light modulator at a position where the modulated light modulated by the modulation part of the spatial light modulator is reflected toward the first annular reflection surface of the first annular reflector. The relay reflector has the outer shape of a right angle prism in which the relay reflection surface is formed on the inclined surface. The first through hole penetrating the relay reflection surface along the horizontal direction and the second through hole penetrating the relay reflection surface along the vertical direction are formed in the relay reflector. The first annular reflector has the first annular reflection surface irradiated with the modulated light modulated by the modulation part. The second annular reflector is disposed concentrically with the first annular reflector. The second annular reflector has the second annular reflection surface irradiated with the modulated light reflected by the first annular reflection surface. The diffusion transmitter includes the annular reflecting mirror, the annular Fresnel lens, and the transparent annular diffuser. The annular reflector is disposed to annularly surround the periphery of the ball lens. The annular reflector reflects the modulated light reflected by the second annular reflection surface of the second annular reflector toward the ball lens. The annular Fresnel lens is disposed to annularly surround the periphery of the ball lens in the ring of the annular reflector. The annular Fresnel lens collects the modulated light reflected by the annular reflector. The transparent annular diffuser is disposed to annularly surround the periphery of the ball lens in the ring of the annular Fresnel lens. The transparent annular diffuser diffuses the modulated light condensed by the annular Fresnel lens. The camera is disposed in the second through hole of the relay reflector with the imaging direction facing upward. The light receiving mirror has a curved light receiving/reflecting surface. The light receiving/reflecting surface reflects light arriving from the horizontal direction toward the second through hole.

The transmitter of the present example embodiment can irradiate a voluntary position of the first annular reflection surface with the modulated light by controlling the pattern (phase image) set in the modulation part of the spatial light modulator. The modulated light irradiated to the first annular reflection surface is irradiated to the diffusion reflector via the second annular reflection surface. The diffusion reflector changes an optical path of the emitted modulated light in a direction along a horizontal plane. The ball lens diffuses the modulated light whose optical path has been changed and transmits the modulated light toward the ball lens. The light whose beam diameter is expanded by the diffusion transmitter is projected as a spatial light signal via the ball lens. Therefore, according to the transmitter of the present example embodiment, it is possible to transmit the spatial light signal with the expanded beam diameter in any direction along the horizontal plane.

The transmitter in the present example embodiment includes the diffusion transmitter having the annular reflecting mirror, the annular Fresnel lens, and the transparent annular diffuser. The communication control device connected to the transmitter of the present example embodiment specifies the presence or absence and the position of the communication target according to the notification light detected by the camera. The communication control device sets a pattern for transmitting the spatial light signal in the specified direction of the communication target in the modulation part of the spatial light modulator. Therefore, according to the transmitter of the present example embodiment, the spatial light signal can be transmitted in the direction of the communication target without mechanically controlling the position of the diffusion transmitter.

### Third Example Embodiment

Next, a transmitter according to a third example embodiment will be described with reference to the drawings. The transmitter of the present example embodiment differs from the transmitters according to the first to second example embodiments in the configuration of the projection unit.

### Configuration

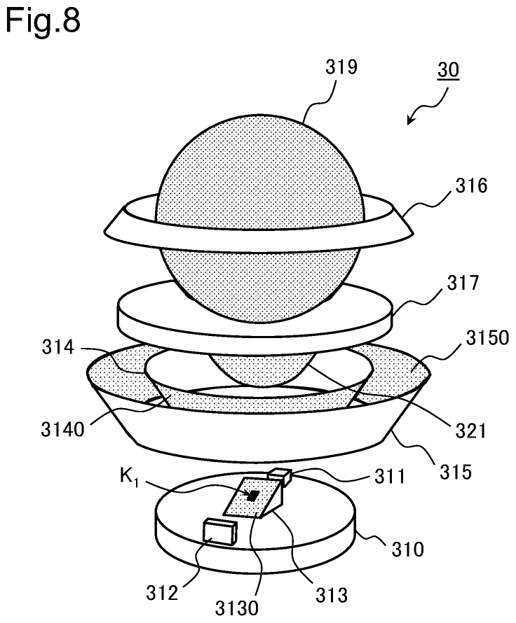

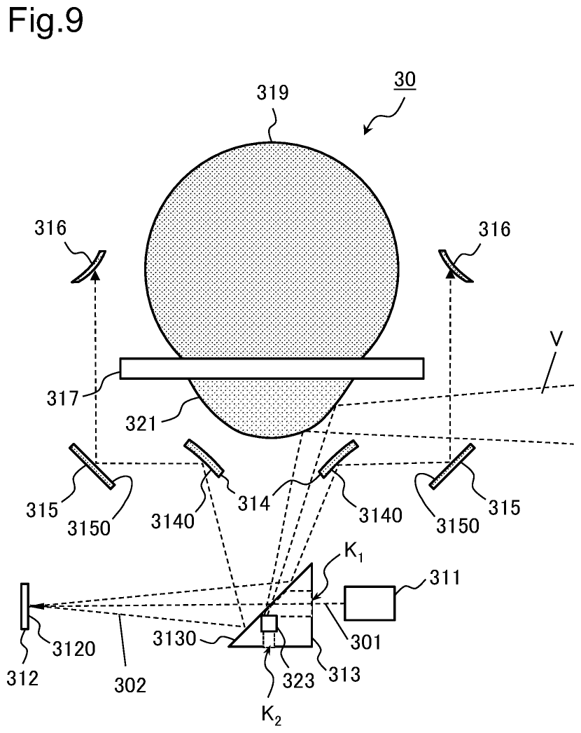

FIGS. 8 and 9 are conceptual diagrams illustrating an example of a configuration of a transmitter according to the present disclosure. FIG. 8 is a perspective view of the configuration of the transmitter according to the present disclosure as viewed from an obliquely upper perspective. FIG. 9 is a cross-sectional view of the configuration of the transmitter according to the present disclosure as viewed from a measurement perspective. Practically, the transmitter 30 is stored inside a housing having an opening or a window for transmitting a spatial light signal.

The transmitter 30 includes a light source 311, a spatial light modulator 312, a relay reflector 313, a first annular reflector 314, a second annular reflector 315, a diffusion transmitter 316, and a ball lens 319. The light source 311, the spatial light modulator 312, and the relay reflector 313 are disposed on an upper surface of a table 310. The first annular reflector 314 and the second annular reflector 315 constitute an annular reflector. The transmitter 30 includes a light receiving mirror 321 and a camera 323. The light receiving mirror 321 and the camera 323 constitute a notification light receiving unit. In a case where the position of the communication target that is the emission source of the notification light is not specified in response to the detection of the notification light, the notification light receiving unit may be omitted. The light source 311, the spatial light modulator 312, the relay reflector 313, the first annular reflector 314, the second annular reflector 315, the ball lens 319, the light receiving mirror 321, and the camera 323 have the same configurations as those of the first example embodiment. Therefore, hereinafter, the description of these configurations will be omitted, and the diffusion transmitter 316 will be mainly described.

The illumination light 301 emitted from the light source 311 is irradiated to the modulation part 3120 of the spatial light modulator 312. A plurality of modulation regions are set in the modulation part 3120. The Illumination light 301 irradiated to the modulation part 3120 is modulated according to a pattern (phase image) set in each of the plurality of modulation regions. The modulated light 302 modulated in each of the plurality of modulation regions travels toward the relay reflection surface 3130 of the relay reflector 313. The relay reflection surface 3130 of the relay reflector 313 is irradiated with the modulated light 302. The modulated light 302 irradiated to the relay reflection surface 3130 is reflected toward the first annular reflection surface 3140 of the first annular reflector 314 disposed above. The modulated light 302 irradiated to the first annular reflection surface 3140 is reflected toward the second annular reflection surface 3150 of the second annular reflector 315 disposed around the first annular reflector 314. The second annular reflection surface 3150 is irradiated with the modulated light 302 reflected by the first annular reflection surface 3140. The modulated light 302 irradiated to the second annular reflection surface 3150 is reflected toward the diffusion transmitter 316.

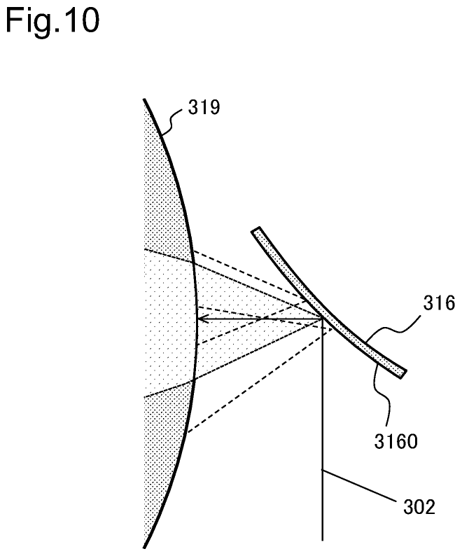

FIG. 10 is a conceptual diagram illustrating an example of a configuration of the diffusion transmitter 316. FIG. 10 is a view of a cross section of the diffusion transmitter 316 as viewed from a side perspective. The diffusion transmitter 316 is a reflective annular diffusion plate that diffusely reflects light in a wavelength band of a spatial light signal (projection light) to be transmitted. The diffusion transmitter 316 has a convex diffuse reflection surface 3160. The diffuse reflection surface 3160 of the diffusion transmitter 316 is directed to the ball lens 319. The modulated light 302 reflected by the second annular reflection surface 3150 of the second annular reflector 315 is incident on the diffuse reflection surface 3160 of the diffusion transmitter 316. The light irradiated to the diffuse reflection surface 3160 of the diffusion transmitter 316 is diffusely reflected according to the radiation angle of the diffuse reflection surface 3160. The light irradiated to the diffuse reflection surface 3160 of the diffusion transmitter 316 is diffusely reflected in a direction corresponding to the irradiation position on the diffuse reflection surface 3160. The light diffusely reflected by the diffuse reflection surface 3160 of the diffusion transmitter 316 travels toward the ball lens 319. By changing the traveling direction of the modulated light 203 by the diffusion transmitter 316, the angle in the vertical direction of the light diffusely reflected by the diffuse reflection surface 3160 changes. The width of the diffusion transmitter 316 in the vertical direction is preferably as narrow as possible so as not to disturb the optical path of the projection light projected from the ball lens 319.

The diffusion transmitter 316 (also referred to as a reflective annular diffuser) is a reflective annular diffusion plate (also referred to as an annular diffusion plate). On the diffuse reflection surface 3160 (convex surface) of the diffusion transmitter 316, minute concave lenses randomly arranged are formed in an array. The modulated light 302 modulated by the modulation part 3120 of the spatial light modulator 312 is incident on the diffuse reflection surface 3160. The emitted modulated light 302 is diffusely reflected by the micro-lens formed on the diffuse reflection surface 3160. The light diffusely reflected by the diffuse reflection surface 3160 travels toward the ball lens 319. The modulated light 302 is diffusely reflected at the position where the micro-lens is formed. Therefore, the range of light to be incident on the ball lens 319 can be shaped according to the range in which the micro-lens is formed.

The material of the base material of the diffusion transmitter 316 is not limited as long as a diffusion layer that diffuses light is formed on the diffuse reflection surface 3160 (concave surface). For example, the micro-lens formed on the diffuse reflection surface 3160 can be formed using a transparent material such as polycarbonate, polyester, acrylic, or glass. The diffusion angle of the diffuse reflection surface 3160 can be adjusted by the state of the micro-lens. As the size of the micro-lens is smaller and the density is larger, the diffusion angle of the diffuse reflection surface 3160 is larger. The diffusion angle of the modulated light 302 reflected by the diffuse reflection surface 3160 may be adjusted according to the diameter of the ball lens 319, the distance between the diffusion transmitter 316 and the ball lens 319, and the like.

The ball lens 319 is disposed on the support base 317. The ball lens 319 is fitted into a recess or an opening formed on the upper surface of the support base 317. The light diffusely reflected by the diffusion transmitter 316 of the diffusion transmitter 316 is incident on the ball lens 319. The ball lens 319 converts the incident light into projection light of substantially parallel light and emits the projection light. The projection light emitted from the ball lens 319 travels toward a communication target (not illustrated) arranged in a direction along the horizontal plane.

As described above, the transmitter of the present example embodiment includes the light source, the spatial light modulator, the relay reflector, the first annular reflector, the second annular reflector, the diffusion transmitter, the ball lens, the camera, and the light receiving reflector. The light source is disposed at a position through which the illumination light passes toward the relay reflection surface via the first through hole of the relay reflector. The light source emits the illumination light. The spatial light modulator includes the modulation part irradiated with the illumination light emitted from the light source. The spatial light modulator is disposed at a position where the relay reflection surface of the relay reflector and the modulation part face each other. The position where the spatial light modulator is disposed is a position where modulated light obtained by modulating the illumination light emitted from the light source is reflected toward the relay reflection surface. The relay reflector is disposed between the light source and the spatial light modulator at a position where the modulated light modulated by the modulation part of the spatial light modulator is reflected toward the first annular reflection surface of the first annular reflector. The relay reflector has the outer shape of a right angle prism in which the relay reflection surface is formed on the inclined surface. The first through hole penetrating the relay reflection surface along the horizontal direction and the second through hole penetrating the relay reflection surface along the vertical direction are formed in the relay reflector. The first annular reflector has the first annular reflection surface irradiated with the modulated light modulated by the modulation part. The second annular reflector is disposed concentrically with the first annular reflector. The second annular reflector has the second annular reflection surface irradiated with the modulated light reflected by the first annular reflection surface. The diffusion transmitter is a reflective annular diffuser. The diffusion transmitter is disposed to annularly surround the periphery of the ball lens. The diffusion transmitter diffusely reflects the modulated light reflected by the second annular reflection surface of the second annular reflector toward the ball lens. The camera is disposed in the second through hole of the relay reflector with the imaging direction facing upward. The light receiving mirror has a curved light receiving/reflecting surface. The light receiving/reflecting surface reflects light arriving from the horizontal direction toward the second through hole.

The transmitter of the present example embodiment can irradiate a voluntary position of the first annular reflection surface with the modulated light by controlling the pattern (phase image) set in the modulation part of the spatial light modulator. The modulated light irradiated to the first annular reflection surface is irradiated to the diffusion reflector via the second annular reflection surface. The diffusion reflector changes an optical path of the emitted modulated light in a direction along a horizontal plane. The ball lens diffuses the modulated light whose optical path has been changed and transmits the modulated light toward the ball lens. The light whose beam diameter is expanded by the diffusion transmitter is projected as a spatial light signal via the ball lens. Therefore, according to the transmitter of the present example embodiment, it is possible to transmit the spatial light signal with the expanded beam diameter in any direction along the horizontal plane.

The transmitter of the present example embodiment includes a reflective annular diffuser as the diffusion transmitter. The communication control device connected to the transmitter of the present example embodiment specifies the presence or absence and the position of the communication target according to the notification light detected by the camera. The communication control device sets a pattern for transmitting the spatial light signal in the specified direction of the communication target in the modulation part of the spatial light modulator. Therefore, according to the transmitter of the present example embodiment, it is possible to transmit the spatial light signal toward the direction of the communication target without mechanically controlling the position of the diffusion transmitter with a simple configuration.

### Fourth Example Embodiment

Next, a communication device according to a fourth example embodiment will be described with reference to the drawings. The communication device of the present example embodiment includes any of the transmitters according to the first to third example embodiments. The communication device of the present example embodiment includes a receiver that receives a spatial light signal. Hereinafter, an example of a receiver having a light receiving function including a ball lens will be described. The communication device of the present example embodiment may include a receiver including a light receiving function that does not include a ball lens. The receiver of the present example embodiment includes a notification optical transmitter that transmits notification light. The notification optical transmitter transmits notification light used to specify a position of a communication device that is an emission source of the notification light.

### Configuration

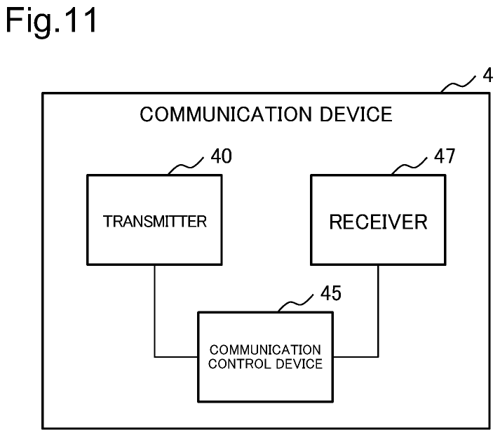

FIG. 11 is a conceptual diagram illustrating an example of a configuration of the communication device according to the present disclosure. The communication device 4 includes a transmitter 40, a communication control device 45, and a receiver 47. The communication device 4 transmits and receives a spatial light signal to and from an external communication target. The transmitter 40 is any one of the transmitters according to the first to third example embodiments. Hereinafter, the description of the transmitter 40 will be omitted, and the communication control device 45 and the receiver 47 will be described.

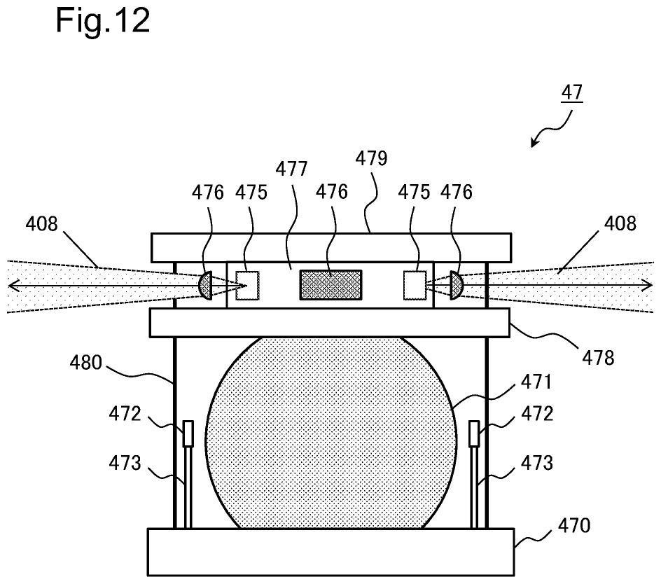

FIG. 12 is a conceptual diagram illustrating an example of a configuration of the receiver 47. FIG. 12 shows the receiver 47 in a side view from a side perspective. The receiver 47 includes a base 470, a ball lens 471, a light receiver 472, a strut 473, a notification light source 475, an optical element 476, a support 477, a support lid 478, a lid 479, and a window 480. The ball lens 471, the light receiver 472, and the strut 473 constitute a receiving unit. The notification light source 475 and the optical element 476 constitute a notification optical transmitter. The base 470 and the strut 473 are moving mechanisms for changing the position of the light receiver 472. In the present example embodiment, an example in which the receiver 47 includes a notification optical transmitter will be described. The notification optical transmitter may be disposed in at least one of the transmitter 40 and the receiver 47.

The base 470 is a table that supports the ball lens 471, the light receiver 472, and the strut 473. A recess or an opening for arranging the ball lens 471 is formed in the center of the upper surface of the base 470. The ball lens 471 is placed in a recess or opening formed at the center of the upper surface of the base 470. A circular orbit (described later) having a circular shape is disposed on the upper surface of the base 470 so as to annularly surround a recess or an opening formed at the center. The circular orbit has a circumference overlapping with the condensing region of the ball lens 471 in a plan view. The strut 473 is movably installed on the circular orbit arranged on the upper surface of the base 470.

The ball lens 471 has the same configuration as the ball lens 119 of the first example embodiment. The ball lens 471 is a spherical optical element (lens). The ball lens 471 collects communication light and notification light (spatial light signal) arriving from the outside. The ball lens 471 has a spherical shape when viewed from a voluntary angle. The ball lens 471 collects the incident spatial light signal. The light (also referred to as an optical signal) derived from the spatial light signal condensed by the ball lens 471 is condensed toward the condensing region of the ball lens 471. Since the ball lens 471 has a spherical shape, the ball lens collects a spatial light signal arriving from a voluntary direction. That is, the ball lens 471 exhibits similar light condensing performance for a spatial light signal arriving from a voluntary direction. The light incident on the ball lens 471 is refracted when entering the inside of the ball lens 471. The light traveling inside the ball lens 471 is refracted again when being emitted to the outside of the ball lens 471. Most of the light emitted from the ball lens 471 is condensed toward the condensing region.

The light receiver 472 is arranged in a condensing region including a condensing point of the ball lens 471 in a state of being supported by the strut 473. The condensing point of the ball lens 471 is not uniquely determined. Therefore, the light receiver 472 is disposed in the condensing region including the condensing point of the ball lens 471. In the example of FIG. 12, the light receiver 472 is disposed on the side of the ball lens 471. The light receiving surface of the light receiver 472 is disposed toward the center of the ball lens 471. A plurality of the light receivers 472 are arranged in an annular portion surrounding the periphery of the ball lens 471.

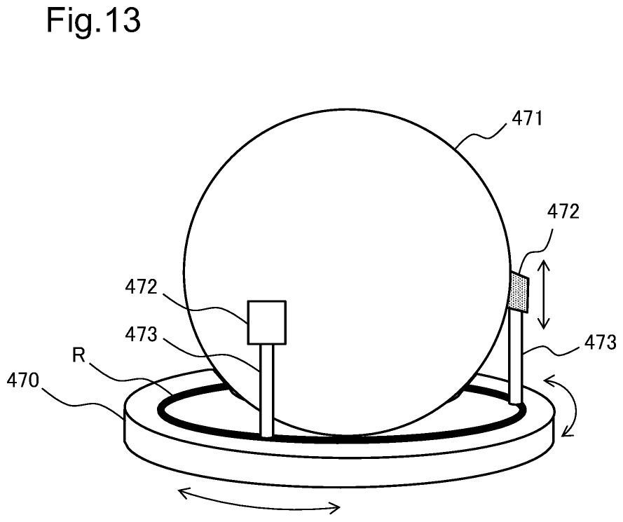

FIG. 13 is a conceptual diagram of the base 470, the ball lens 471, the light receiver 472, and the strut 473 viewed from an obliquely upper perspective. A circular orbit R is arranged on the upper surface of the base 470. The strut 473 is disposed on the circular orbit R. The height of the light receiver 472 is changed in accordance with expansion and contraction of the strut 473. The position of the light receiver 472 in the horizontal plane is changed according to the position of the strut 473. Therefore, the position of the light receiving surface of the light receiver 472 can be adjusted according to the expansion/contraction and the position of the strut 473.

The light receiver 472 is used to receive a spatial light signal (notification light and communication light) transmitted from a communication target. The light receiver 472 includes at least one light receiving element having sensitivity to light in the wavelength band of the spatial light signal. The spatial light signal received by the light receiver 472 is converted into an electric signal. The converted electric signal is output to the communication control device 45.

For example, the light receiver 472 includes a first light receiving element and a second light receiving element. The first light receiving element is used to receive the notification light. In the second light receiving element, the light receiving surface of the first light receiving element has a larger area than the light receiving surface of the second light receiving element used for receiving communication light for communication. The first light receiving element has sensitivity to light in the wavelength band of the notification light. For example, the first light receiving element is achieved by a silicon-based photodiode. The notification light received by the first light receiving element is converted into an electric signal. The converted electric signal is output to the communication control device 45. The second light receiving element is disposed on the light receiving surface of the first light receiving element. The second light receiving element has sensitivity to light in the wavelength band of the communication light. For example, the second light receiving element is achieved by a photodiode having sensitivity to infrared rays. For example, the second light receiving element is achieved by an indium gallium arsenide InGaAs-based photodiode. The communication light received by the second light receiving element is converted into an electric signal. The converted electric signal is output to the communication control device 45.

The strut 473 is a column that supports the light receiver 472. The light receiver 472 is disposed above the strut 473. The strut 473 has a structure that expands and contracts in the vertical direction. The height of the strut 473 vertically moves up and down under the control of the communication control device 45. The lower portion of the strut 473 is installed so as to be movable with respect to the circular orbit R arranged on the upper surface of the base 470. The position of the strut 473 is changed along the circular orbit R according to the control of the communication control device 45.

The notification light source 475 emits radiation light having a larger projection angle (radiation angle) than communication light. For example, the notification light source 475 includes a light-emitting diode LED (Light-Emitting Diode). For example, the notification light source 475 emits radiation light in a wavelength band of 850 to 950 nanometers. The receiver 47 includes a plurality of notification light sources 475. The plurality of notification light sources 475 are arranged with the emission surface facing a direction parallel to the horizontal plane. The plurality of notification light sources 475 are arranged with the emission surfaces facing different directions. The optical element 476 is arranged in the direction of the emission surface of the notification light source 475.

The optical element 476 is an element for projecting the radiation light emitted from the notification light source 475 as the notification light 408. In FIG. 12, a structure for supporting the optical element 476 is omitted. The incident surface of the optical element 476 is directed to the emission surface of the notification light source 475. The incident surface of the optical element 476 is irradiated with radiation light emitted from the notification light source 475. The emission surface of the optical element 476 is directed in a direction parallel to the horizontal plane. The radiation light with which the incident surface of the optical element 476 is irradiated is emitted from the emission surface as the notification light 408. The notification light 408 is light for notifying a communication target arranged at the same height as the horizontal plane on which the communication device 4 is arranged of the position of the own device.

For example, the optical element 476 is achieved by a plano-convex cylindrical lens including a flat surface and a curved surface. In the plano-convex cylindrical lens, a flat surface is an incident surface, and a convex surface is an emission surface. The flat surface (incident surface) of the plano-convex cylindrical lens is directed to the emission surface of the notification light source 475. The radiation light incident from the flat surface (incident surface) is radiated as the notification light 408 from the convex surface (emission surface).

For example, the optical element 476 is achieved with a concave mirror having a curvature in the vertical direction. The concave surface of the concave mirror is a reflecting surface. The concave surface (reflecting surface) of the concave mirror is directed to the emission surface of the notification light source 475. The radiation light emitted to the concave surface (reflecting surface) of the concave mirror is reflected by the concave surface (reflecting surface) and emitted as the notification light 408.

The support 477 is a structure that supports the notification light source 475. The support 477 is disposed on the upper surface of the support lid 478. A plurality of notification light sources 475 are disposed on the side surface of the support 477. Inside the support 477, a power supply and a drive unit used for driving the notification light source 475 and the like are arranged. The communication control device 45 may be disposed inside the support 477.

The support lid 478 is disposed above the ball lens 471. A recess or an opening for fitting the upper portion of the ball lens 471 is formed at the center of the lower surface of the support lid 478. The upper portion of the ball lens 471 is fitted into a recess or an opening formed at the center of the lower surface of the support lid 478. The support 477 is disposed on the upper surface of support lid 478. The material and shape of the support lid 478 are not particularly limited.

The lid 479 is disposed above the window 480. The support 477 is disposed on the lower surface of the lid 479. The material and shape of the lid 479 are not particularly limited.

The window 480 is an element that removes unnecessary light and selectively transmits a spatial light signal used for communication. The window 480 serves as a strut for placing the lid 479 thereon. The material of the window 480 is not particularly limited as long as light in the wavelength band of the spatial light signal is transmitted and the window is not deformed even when the lid 479 is placed on the window. The spatial light signal (communication light, notification light) travels through the window 480.

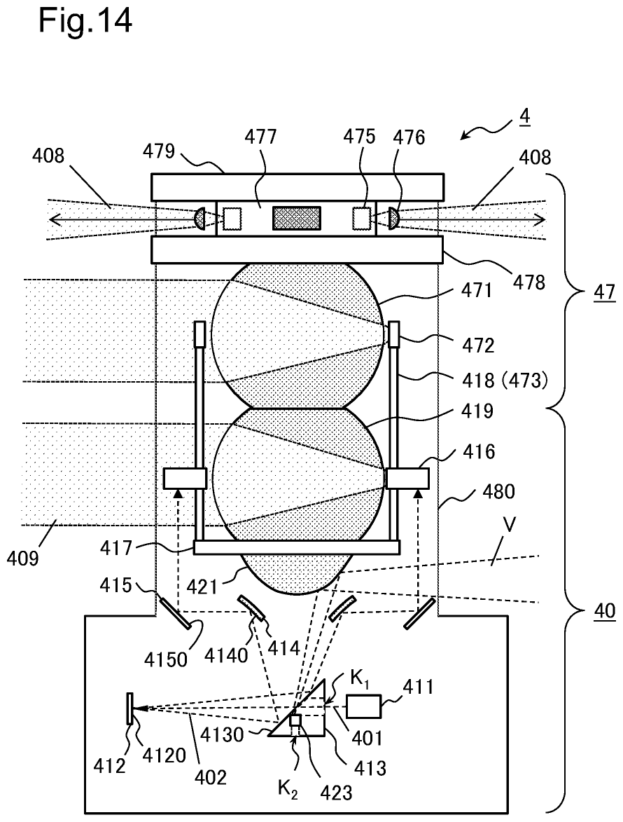

FIG. 14 is a conceptual diagram illustrating an example of a configuration of the communication device 4 in which the transmitter 40 and the receiver 47 are combined. FIG. 14 is a diagram of the configuration of the communication device 4 as viewed from a side perspective. FIG. 14 illustrates a cross section of a part of the transmitter 40.

The transmitter 40 has a configuration similar to that of the transmitter 10 in the first example embodiment. The transmitter 40 may be configured similarly to the transmitter 20 in the second example embodiment or the transmitter 30 in the third example embodiment. The transmitter 40 includes a light source 411, a spatial light modulator 412, a relay reflector 413, a first annular reflector 414, a second annular reflector 415, a diffusion transmitter 416, a support base 417, a strut 418, and a ball lens 419. The first annular reflector 414 and the second annular reflector 415 constitute an annular reflector. The strut 418 is coupled with the strut 473 of the receiver 47. In the present example embodiment, the strut 418 and the strut 473 are configured by one column. The transmitter 40 includes a light receiving mirror 421 and a camera 423. The light receiving mirror 421 and the camera 423 constitute a notification light receiving unit. In a case where the position of the communication target that is the emission source of the notification light is not specified in response to the detection of the notification light, the notification light receiving unit may be omitted. Since the configuration of the transmitter 40 is similar to that of the transmitter 10 in the first example embodiment, detailed description thereof is omitted.

In the configuration of FIG. 14, the support base 417 of the transmitter 40 also serves as the base 470 (rotation mechanism) of the receiver 47. The ball lens 471 of the receiver 47 is placed above the ball lens 419. The upper surface of the ball lens 419, the lower surface of the ball lens 471, and a planar portion are provided. The lower surface of the ball lens 419 processed into a planar shape is aligned with the upper surface of the ball lens 471 processed into a planar shape, whereby the ball lens 471 is placed above the ball lens 419.

Light V arriving at the transmitter 10 from the direction along the horizontal plane is reflected by the reflecting surface of the light receiving mirror 421 and is reflected toward the second through hole K₂ of the relay reflector 413. The camera 423 images an image of the light V reflected by the reflecting surface of the light receiving mirror 421. The camera 423 outputs image data corresponding to the imaged light V to the communication control device 45.

In the configuration of FIG. 14, the strut 418 of the transmitter 40 also serves as the strut 473 of the receiver 47. The positions of the diffusion transmitter 416 and the light receiver 472 arranged on the common strut 418 (strut 473) are changed according to the movement and expansion and contraction of the strut 418. The light transmission surface of the diffusion transmitter 416 and the light receiving surface of the light receiver 472 arranged on the common strut 418 face the same direction.

In response to the light reception of the spatial light signal (notification light and communication light) by the light receiver 472, the movement of the strut 418 is changed such that the light receiving surface of the light receiver 472 faces the arrival direction of the spatial light signal. As a result, the transmission surface of the diffusion transmitter 416 disposed on the strut 418 (strut 473) faces the arrival direction of the spatial light signal. That is, according to the configuration of FIG. 14, by directing the light receiving surface of the light receiver 472 in the arrival direction of the spatial light signal, the light transmission surface of the diffusion transmitter 416 can be directed in the direction of the communication target of the transmission source of the spatial light signal.

The illumination light 401 emitted from the light source 411 of the transmitter 40 is irradiated to the modulation part 4120 of the spatial light modulator 412. A plurality of modulation regions are set in the modulation part 4120. The Illumination light 401 irradiated to the modulation part 4120 is modulated according to a pattern (phase image) set in each of the plurality of modulation regions. The modulated light 402 modulated in each of the plurality of modulation regions travels toward the relay reflection surface 4130 of the relay reflector 413. The relay reflection surface 4130 of the relay reflector 413 is irradiated with the modulated light 402. The modulated light 402 irradiated to the relay reflection surface 4130 is reflected toward the first annular reflection surface 4140 of the first annular reflector 414 disposed above. The modulated light 402 irradiated to the first annular reflection surface 4140 is reflected toward the second annular reflection surface 4150 of the second annular reflector 415 disposed around the first annular reflector 414. The second annular reflection surface 4150 is irradiated with the modulated light 402 reflected by the first annular reflection surface 4140. The modulated light 402 irradiated to the second annular reflection surface 4150 is reflected toward the diffusion transmitter 416. The modulated light 402 emitted to the diffusion transmitter 416 is changed in its optical path by the diffusion transmitter 416 in the direction of the ball lens 419, diffused, and emitted. The light emitted from the diffusion transmitter 416 is incident on the ball lens 419. The ball lens 419 converts the incident light into projection light 409 of substantially parallel light and emits the projection light. The projection light 409 emitted from the ball lens 419 travels toward the communication target (not illustrated) arranged in the direction along the horizontal plane.

The communication control device 45 controls the transmitter 40 and the receiver 47. For example, the communication control device 45 is achieved by a computer or a microcomputer including a processor and a memory. The communication control device 45 specifies another communication device based on the received notification light. The communication control device 45 establishes the spatial light communication using the spatial light signal between the specified other communication device and the communication control device. The communication control device 45 acquires a signal based on the spatial light signal from the other communication device received by the receiver 47. The communication control device 45 executes processing according to the acquired signal. The communication control device 45 causes the transmitter 40 to transmit the spatial light signal directed to the other communication target.

The communication control device 45 controls the notification light source 475 of the receiver 47. The communication control device 45 controls the notification light source 475 such that the notification light 408 is emitted with a modulation pattern unique to the communication device 4 at the radiation timing of the notification light 408. For example, the communication control device 45 controls the notification light source 475 so that the notification light 408 modulated with the unique modulation frequency f is emitted at the radiation timing set at the predetermined time interval. The modulation frequency f is not particularly limited. For example, the modulation frequency f is set to about 300 hertz. The radiation timing of the notification light 408 is set to a radiation pattern unique to the communication device 4. The radiation timing of the notification light 408 may be a constant time interval or a preset regularly changing time interval. The radiation timing of the notification light 408 may be a time interval that randomly changes. In order to identify each communication device 4, the modulation frequency of the notification light 408 is set to a modulation pattern unique to each communication device 4. For example, each communication device 4 is identified by a pattern of radiation timing of the notification light 408.

The communication control device 45 acquires an electric signal derived from the notification light received by the light receiver 472 of the receiver 47. The communication control device 45 detects a modulation signal to be received from a signal in a frequency band to be received among the acquired electrical signals. The communication control device 45 integrates the detected modulation signal. The communication control device 45 converts the integrated modulation signal (analog signal) into a digital signal. The communication control device 45 controls the position of the light receiver 472 used for communication with the communication target based on the converted digital signal. The communication control device 45 controls the position of the light receiver 472 used for communication with the communication target at a position where the strength of the digital signal is maximized. With such control, the light receiver 472 associated with the communication target is arranged at the position where the light reception intensity is maximized.

The communication control device 45 controls the light source 411 and the spatial light modulator 412 of the transmitter 40. The communication control device 45 sets a phase image corresponding to the projected image in the modulation part 4120. The communication control device 45 sets the phase image corresponding to the projected image in the modulation region set in the modulation part 4120 of the spatial light modulator 412. The communication control device 45 sets the phase image corresponding to the displayed image in the modulation region. The communication control device 45 drives the light source 411 in a state where the phase image is set in the modulation region. As a result, the modulation region in which the phase image is set is irradiated with the illumination light 401 emitted from the light source 411. The Illumination light 401 irradiated to the modulation part 4120 is modulated in the modulation region. The modulated light 402 modulated in the modulation region travels toward the first annular reflection surface 4140 of the first annular reflector 414.

The communication control device 45 modulates the illumination light 401 emitted from the light source 411 for communication with the communication target (not illustrated). In communication, the communication control device 45 controls the timing at which the illumination light 401 is emitted from the light source 411 in a state where the phase image for communication is set in the modulation part 4120 of the spatial light modulator 412. By such control, the illumination light 401 is modulated. The modulation pattern of the illumination light 401 in the communication is arbitrarily set. For example, a communication unit (not illustrated) is added in addition to the communication control device 45. The communication control device 45 may be configured to control the light source 411 and the spatial light modulator 412 according to the condition set by the communication unit.

The communication control device 45 acquires the electric signal derived from the signal light received by the light receiver 472 of the receiver 47. The communication control device 45 detects a modulation signal to be received from a signal in a frequency band to be received among the acquired electrical signals. The communication control device 45 amplifies the input signal. The communication control device 45 decodes the amplified signal. For example, the communication control device 45 may perform some signal processing on the decoded signal. The communication control device 45 outputs the decoded signal. For example, the communication control device 45 outputs the decoded signal to the external signal processing device or the like (not illustrated). For example, the communication control device 45 may cause a display device (not illustrated) to display information corresponding to the decoded signal. The use of the signal output from the communication control device 45 is not particularly limited.

### Application Example

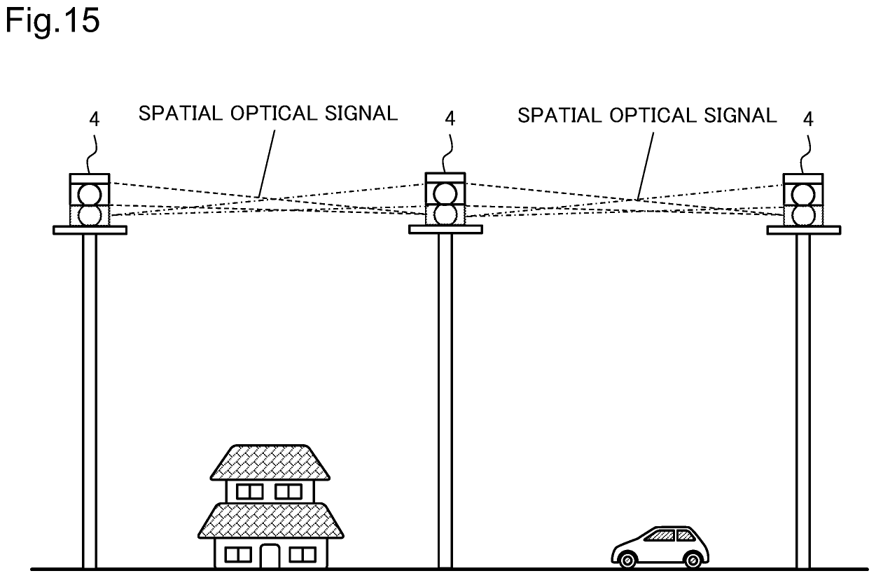

Next, an application example of the present example embodiment will be described with reference to the drawings. In the following application example, an example in which a plurality of communication devices 4 transmit and receive spatial light signals will be described. FIG. 15 is a conceptual diagram for describing the present application. In the present application example, an example (communication system) of a communication network in which the plurality of communication devices 4 are arranged on an upper portion (space above pole) of a pole such as a utility pole or a street lamp arranged in a town will be described.

There are few obstacles in the space above the pole. Therefore, the space above the pole is suitable for installation of the communication device 4. When the communication device 4 is installed at the same height, the arrival direction of the spatial light signal is limited to the horizontal direction. The pair of communication devices 4 transmitting and receiving the spatial light signal is arranged at a position where at least one communication device 4 can receive the spatial light signal transmitted from the other communication device 4. The pair of communication devices 4 may be arranged to transmit and receive spatial light signals to and from each other. In a case where a communication network of spatial light signals is configured by the plurality of communication devices 4, the communication device 4 positioned in the middle may be configured to relay a spatial light signal transmitted from another communication device 4 to another communication device 4.

According to the present application example, it is possible to perform optical space communication using a spatial light signal among the plurality of communication devices 4 arranged in the space above the pole. For example, in addition to the optical space communication between the communication devices 4, communication by wireless communication using radio waves may be performed between the communication device 4 and a wireless device or a base station installed in an automobile, a house, or the like. For example, the communication device 4 may be connected to the Internet via a communication cable or the like installed on a pole.

As described above, the communication device of the present example embodiment includes a transmitter, a receiver, and a communication control device. The transmitter is the transmitter according to any one of the first to third example embodiments. The receiver receives the spatial light signal transmitted from another communication target. The communication control device acquires a signal based on a spatial light signal from another communication device received by the receiver. The communication control device executes processing according to the acquired signal. The communication control device causes the transmitter to transmit a spatial light signal directed to another communication target.

The communication device according to the present example embodiment includes a transmitter capable of transmitting a spatial light signal with an expanded beam diameter in any direction along a horizontal plane. Therefore, the communication device of the present example embodiment can transmit the spatial light signal toward the transmission source of the spatial light signal based on the spatial light signal arriving from a voluntary azimuth.

A communication device according to an aspect of the present example embodiment includes a notification optical transmitter that transmits notification light modulated with a unique modulation frequency in a direction along a horizontal plane. The communication control device specifies another communication device based on the received notification light. The communication control device establishes spatial light communication using a spatial light signal with another specified communication device. According to the present aspect, spatial light communication using a spatial light signal can be established with a communication device that is a transmission source of a spatial light signal based on the spatial light signal arriving from a voluntary azimuth.

A communication system according to an aspect of the present example embodiment includes a plurality of the above-described communication devices. In a communication system, a plurality of communication devices are arranged to transmit and receive spatial light signals to and from each other. According to the present aspect, it is possible to achieve a communication network that transmits and receives a spatial light signal.

### Fifth Example Embodiment

Next, a transmitter according to a fifth example embodiment will be described with reference to the drawings. The transmitter of the present example embodiment has a simplified configuration of the transmitters of the first to third example embodiments.

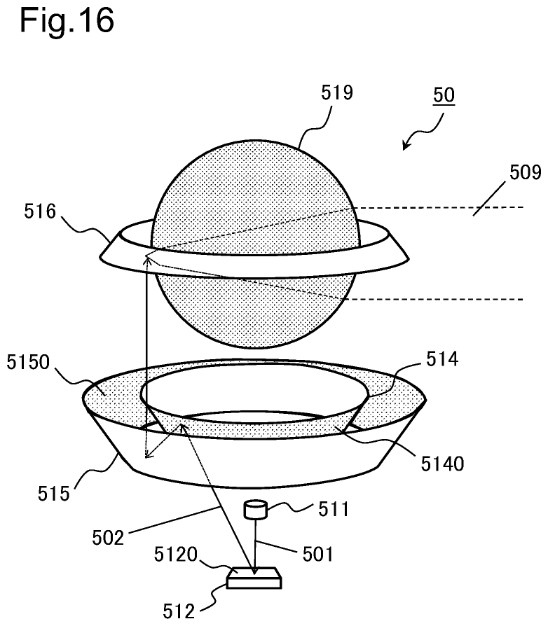

FIG. 16 is a conceptual diagram illustrating an example of a configuration of a transmitter according to the present disclosure. FIG. 16 is a diagram of the transmitter 50 viewed from an obliquely upper perspective. The transmitter 50 includes a light source 511, a spatial light modulator 512, a first annular reflector 514, a second annular reflector 515, a diffusion transmitter 516, and a ball lens 519. In FIG. 16, a structure for fixing the positions of the light source 511, the spatial light modulator 512, the first annular reflector 514, the second annular reflector 515, the diffusion transmitter 516, and the ball lens 519 is omitted.

The light source 511 emits the illumination light 501. The spatial light modulator 512 includes a modulation part 5120 irradiated with the illumination light 501 emitted from the light source 511. The first annular reflector 514 has a first annular reflection surface 5140 irradiated with the modulated light 502 modulated by the modulation part 5120. The second annular reflector 515 is disposed concentrically with the first annular reflector 514. The second annular reflector 515 has a second annular reflection surface 5150 irradiated with the modulated light 502 reflected by the first annular reflection surface 5140. The diffusion transmitter 516 is irradiated with the modulated light 502 reflected by the second annular reflection surface 5150. The diffusion transmitter 516 changes the optical path of the emitted modulated light 502 in a direction along the horizontal plane. The diffusion transmitter 516 diffuses and transmits the modulated light 502 whose optical path has been changed. The ball lens 519 projects light (projection light 509) transmitted from the diffusion transmitter 516.

The transmitter of the present example embodiment can irradiate a voluntary position of the first annular reflection surface with the modulated light by controlling the pattern (phase image) set in the modulation part of the spatial light modulator. The modulated light irradiated to the first annular reflection surface is irradiated to the diffusion reflector via the second annular reflection surface. The diffusion reflector changes an optical path of the emitted modulated light in a direction along a horizontal plane. The ball lens diffuses the modulated light whose optical path has been changed and transmits the modulated light toward the ball lens. The light whose beam diameter is expanded by the diffusion transmitter is projected as a spatial light signal via the ball lens. Therefore, according to the transmitter of the present example embodiment, it is possible to transmit the spatial light signal with the expanded beam diameter in any direction along the horizontal plane.

### (Hardware)

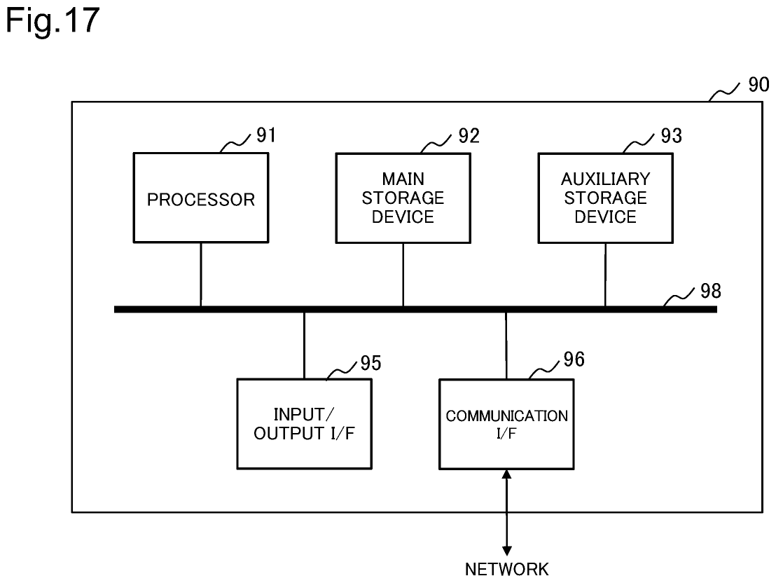

Next, a hardware configuration for executing control and processing according to each example embodiment of the present disclosure will be described with reference to the drawings. Here, an example of such a hardware configuration is an information processing apparatus 90 (computer) in FIG. 17. The information processing apparatus 90 in FIG. 17 is a configuration example for executing control and processing of each example embodiment, and does not limit the scope of the present disclosure.

As illustrated in FIG. 17, the information processing apparatus 90 includes a processor 91, a main storage device 92, an auxiliary storage device 93, an input/output interface 95, and a communication interface 96. In FIG. 17, the interface is abbreviated as an interface (I/F). The processor 91, the main storage device 92, the auxiliary storage device 93, the input/output interface 95, and the communication interface 96 are data—communicably connected to each other via a bus 98. The processor 91, the main storage device 92, the auxiliary storage device 93, and the input/output interface 95 are connected to a network such as the Internet or an intranet via the communication interface 96.

The processor 91 develops a program (command) stored in the auxiliary storage device 93 or the like in the main storage device 92. For example, the program is a software program for executing control and processing of each example embodiment. The processor 91 executes the program developed in the main storage device 92. The processor 91 executes the program to execute control and processing according to each example embodiment.

The main storage device 92 has an area in which a program is developed. A program stored in the auxiliary storage device 93 or the like is developed in the main storage device 92 by the processor 91. The main storage device 92 is achieved by, for example, a volatile memory such as a dynamic random access memory (DRAM). A nonvolatile memory such as a magneto-resistive random access memory (MRAM) may be configured/added as the main storage device 92.

The auxiliary storage device 93 stores various data such as programs. The auxiliary storage device 93 is achieved by a local disk such as a hard disk or a flash memory. Various data may be stored in the main storage device 92, and the auxiliary storage device 93 may be omitted.

The input/output interface 95 is an interface for connecting the information processing apparatus 90 and a peripheral device based on a standard or a specification. The communication interface 96 is an interface for connecting to an external system or device through a network such as the Internet or an intranet based on a standard or a specification. The input/output interface 95 and the communication interface 96 may be shared as an interface connected to an external device.

Input devices such as a keyboard, a mouse, and a touch panel may be connected to the information processing apparatus 90 as necessary. These input devices are used to input information and settings. When a touch panel is used as the input device, a screen having a touch panel function serves as an interface. The processor 91 and the input device are connected via the input/output interface 95.

The information processing apparatus 90 may be provided with a display device for displaying information. In a case where a display device is provided, the information processing apparatus 90 includes a display control device (not illustrated) for controlling display of the display device. The information processing apparatus 90 and the display device are connected via the input/output interface 95.

The information processing apparatus 90 may be provided with a drive device. The drive device mediates reading of data and a program stored in a recording medium and writing of a processing result of the information processing apparatus 90 to the recording medium between the processor 91 and the recording medium (program recording medium). The information processing apparatus 90 and the drive device are connected via an input/output interface 95.

The above is an example of a hardware configuration for enabling control and processing according to each example embodiment of the present disclosure. The hardware configuration of FIG. 17 is an example of a hardware configuration for executing control and processing according to each example embodiment, and does not limit the scope of the present disclosure. A program for causing a computer to execute control and processing according to each example embodiment is also included in the scope of the present disclosure.

A program recording medium in which the program according to each example embodiment is recorded is also included in the scope of the present disclosure. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. The recording medium may be achieved by a magnetic recording medium such as a flexible disk, or another recording medium. When a program executed by the processor is recorded in a recording medium, the recording medium corresponds to a program recording medium.

The components of the example embodiments may be arbitrarily combined. The components of the example embodiments may be achieved by software. The components of each example embodiment may be achieved by a circuit.

The previous description of embodiments is provided to enable a person skilled in the art to make and use the present invention. Moreover, various modifications to these example embodiments will be readily apparent to those skilled in the art, and the generic principles and specific examples defined herein may be irradiated to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A transmitter comprising:
a light source that emits illumination light;
a spatial light modulator that includes a modulation part to which the illumination light emitted from the light source is irradiated;
a first annular reflector that has a first annular reflection surface irradiated with modulated light modulated by the modulation part;
a second annular reflector that is disposed concentrically with the first annular reflector and has a second annular reflection surface irradiated with the modulated light reflected by the first annular reflection surface;
a diffusion transmitter that is irradiated with the modulated light reflected by the second annular reflection surface, changes an optical path of the irradiated modulated light in a direction along a horizontal plane, and diffuses and transmits the modulated light having the changed optical path; and
a ball lens that projects the light transmitted from the diffusion transmitter.

2. The transmitter according to claim 1, wherein
the diffusion transmitter is disposed in a condensing region of the ball lens by a strut installed in such a way as to be movable along a circular orbit overlapping with the condensing region of the ball lens in a plan view.

3. The transmitter according to claim 2, wherein
the diffusion transmitter includes
a reflecting mirror that reflects the modulated light reflected by the second annular reflection surface of the second annular reflector toward the ball lens,
a lens that condenses the modulated light reflected by the reflecting mirror, and
a transparent diffuser that diffuses the modulated light condensed by the lens.

4. The transmitter according to claim 1, wherein
the diffusion transmitter includes
an annular reflector that is disposed to annularly surround a periphery of the ball lens and reflects the modulated light reflected by the second annular reflection surface of the second annular reflector toward the ball lens,
an annular Fresnel lens that is disposed to annularly surround the periphery of the ball lens in a ring of the annular reflector and collects the modulated light reflected by the annular reflector, and
a transparent annular diffuser that is disposed to annularly surround the periphery of the ball lens in the ring of the annular Fresnel lens and diffuses the modulated light condensed by the annular Fresnel lens.

5. The transmitter according to claim 1, wherein
the diffusion transmitter is a reflective annular diffuser that is disposed to annularly surround a periphery of the ball lens and diffusely reflects the modulated light reflected by the second annular reflection surface of the second annular reflector toward the ball lens.

6. The transmitter according to claim 1, further comprising
a relay reflector that is disposed between the light source and the spatial light modulator, has an outer shape of a right angle prism in which a relay reflection surface is formed on an inclined surface, and has a first through hole penetrating the relay reflection surface along a horizontal direction, wherein
the light source is disposed at a position through which the illumination light passes toward the relay reflection surface side via the first through hole of the relay reflector,
the spatial light modulator is disposed at a position where the relay reflection surface of the relay reflector and the modulation part face each other, and the modulated light obtained by modulating the illumination light emitted from the light source is reflected toward the relay reflection surface, and
the relay reflector is disposed at a position where the modulated light modulated by the modulation part of the spatial light modulator is reflected toward the first annular reflection surface of the first annular reflector.

7. The transmitter according to claim 1, further comprising:
a relay reflector that is disposed between the light source and the spatial light modulator, has an outer shape of a right angle prism in which a relay reflection surface is formed on an inclined surface, and is formed with a first through hole penetrating the relay reflection surface along a horizontal direction and a second through hole penetrating the relay reflection surface along a vertical direction;
a camera that is disposed in the second through hole of the relay reflector with an imaging direction facing upward; and
a light receiving mirror that has a curved light receiving/reflecting surface that reflects light arriving from a horizontal direction toward the second through-hole, wherein
the light source is disposed at a position through which the illumination light passes toward the relay reflection surface side via the first through hole of the relay reflector,
the spatial light modulator is disposed at a position where the relay reflection surface of the relay reflector and the modulation part face each other, and the modulated light obtained by modulating the illumination light emitted from the light source is reflected toward the relay reflection surface, and
the relay reflector is disposed at a position where the modulated light modulated by the modulation part of the spatial light modulator is reflected toward the first annular reflection surface of the first annular reflector.

8. A communication device comprising:
the transmitter according to claim 1;
a receiver that receives a spatial light signal transmitted from another communication target; and
a communication control device comprising
a memory storing instructions, and
a processor connected to the memory and configured to execute the instructions to
acquire a signal based on the spatial light signal from the other communication device received by the receiver,
execute processing according to the acquired signal, and
cause the transmitter to transmit the spatial light signal toward the other communication target.

9. The communication device according to claim 8, further comprising
a notification optical transmitter that transmits notification light modulated with a unique modulation frequency in a direction along a horizontal plane, wherein
the processor of the communication control device is configured to execute the instructions to
specify the other communication device based on the received notification light, and
establish spatial light communication using the spatial light signal between the specified other communication device and the communication control device.

10. A communication system comprising a plurality of the communication devices according to claim 9, wherein
the plurality of communication devices are disposed to transmit and receive spatial light signals to and from each other.
